(19) United States
(12) Patent Application Publication
(10) Pub. No.: US 2012/0110787 A1
(43) Pub. Date: May 10, 2012

(54) IMPLEMENT HANDLE WITH ERGONOMIC GRIP PROVIDING ROTATIONAL LEVERAGE

(75) Inventors: James Quiggins, Houston, TX (US); Lawrence Snapp, Manhattan Beach, CA (US); Craig Hagedorn, Houston, TX (US)

(73) Assignee: CLIPPER CORPORATION, Carson, CA (US)

(21) Appl. No.: 12/940,189

(22) Filed: Nov. 5, 2010

(51) Int. Cl. B25G 1/10; B25G 1/00

(52) U.S. Cl. 16/430; 16/110.1

(57) ABSTRACT

An implement, handle has its axially elongate body widened proximal to its attachment end to define a thumb rest that provides leverage for axial rotation and turning of the implement, such as a cooking pan or skillet. The elongate body may be in the form of an elastomer sleeve fitted over a rigid shaft, wherein the shaft may have an attached metal cross-plate or integral crossbar to add mechanical strength to the thumb rest.

### TECHNICAL FIELD

The present invention relates to handles and gripping utensils, especially those adapted for cooking implements, such as skillets or fry pans, including sleeve-type handles and grips of injection-molded polymers on shank-type handles, and cast metal handles with grips, as well as grips that are intended to be detachable or removable from a fixed handle.

### BACKGROUND ART

In cooking, the acts of plating and pouring typically require pronation of the forearm on the part of the cook. Sauté pans, skillets and fry pans are often heavy even when empty, and when loaded with food a sure grip is essential in order not to drop a pan and spill its contents. A firm grip is also essential in order to create sufficient torque to rotate a heavy pan. However, during the forearm pronation for plating or pouring action, a combination of arm extension together with a tight grip is bad, and repeated pronation with such a tight grip can lead to repetitive stress injuries and carpal tunnel syndrome. Professional chefs repeat such motions frequently during each workday and can suffer work-related injuries due to poor handle design of the cooking implements.

It should be noted that forearm flexion while tossing or sautéing is not as stressful as pronation while plating or pouring. One prior improvement in cooking implement design is to angle the handle upward by 5° to 12° above the horizontal in order to lock the wrist extension. Unfortunately, this does little to reduce the stress involved in rotating a pan for plating or pouring.

U.S. Pat. No. 4,197,611 Bell et al. describes a thermally insulated handgrip in the form of a sleeve to be slipped over metal handles of cooking utensils. The grip has external ribs to provide a better gripping surface for the user.

U.S. Pat. No. 5,737,803 to Tisdale and U.S. Reissued Pat. RE37,190 to Stowell et al. describe thumb depressions in handles for firmly gripping household tools.

U.S. Pat. No. 6,009,600 to Egeland et al. describes a tool handle (e.g., for a hammer) that includes a thumb ramp that allows a user's thumb to help guide the tool in a striking motion for improved accuracy and control.

Opportunities exist for ergonomic improvement in handles so as to reduce the forces required for providing sufficient torque to rotate an implement about the axis defined by the handle. This would enable turning of an implement with a looser grip and with reduced stresses on the forearm.

### SUMMARY DISCLOSURE

A handle in accord with the present invention comprises an axially elongate body that is widened proximal to an attachment end so as to define a thumb rest that provides leverage for axial rotation. The attachment end of the elongate body is defined as that end which is adapted to receive an implement, whereas the other end distal from the implement is called the free end. The thumb rest extends laterally outward from sides of the elongate body. The handles and their grips can cover a variety of known materials (e.g., silicone rubber, phenolic plastic, or other polymers, as well as non-precious metals), construction methods (injection molding, casting, etc.) and attachment styles (permanent or removable). For example, the elongate body can be in the form of a sleeve adapted to fit over a rigid shaft extending from the implement. The sleeve material could also be injected molded onto the shaft. This sleeve, which defines a grip for the handle, may be affixed to the shaft or can be removable. While the handle in accord with the present invention is often used for cooking pan type implements, it can also be used in other implements or tools for cooking (spoons, spatulas, etc.) or other tools, particularly where repeated turning motions or pronation are frequent.

### BRIEF DESCRIPTION OF THE DRAWINGS

FIG. 1 is a perspective view of an embodiment of a handle with widened thumb rest in accord with the present invention connected to a cooking implement.

FIG. 2 is perspective view of a metal cross-plate that may be provided within the handle of FIG. 1 to provide additional mechanical strength to the thumb rest.

FIG. 3 is a top partial view of a handle as in FIG. 1 being gripped by a hand with placement of a thumb upon the widened thumb rest.

FIG. 4 is a perspective view of an embodiment of a handle connected to a cooking implement, with the handle's outer sleeve removed to reveal its underlying rigid shaft with integral crossbar at a location corresponding to the thumb rest.

FIG. 5 is a top plan view of the handle in FIG. 4, together with its outer sleeve.

FIG. 6 is a side view of the handle in FIGS. 4 and 5, showing the presence of a set of spaced apart ridges defining finger depressions therebetween.

FIG. 7 is a perspective view of another embodiment of a handle connected to a cooking implement.

FIGS. 8A and 8B are perspective views of two handle shafts having different curvatures for use in the handle of FIG. 7.

FIG. 9 is a close-up view of the handle of FIG. 7 showing dimple texture features distributed over a portion of the handle surface and a ball knob terminating the free end of the handle.

FIGS. 10 and 11 are respective side and top plan views of another embodiment of a handle in accord with the present invention, featuring sets of elastomer ridges or fins to define flexible finger depressions in the handle surface.

FIGS. 12 and 13 are perspective view of other representative implements (spoon, spatula) having a handle in accord with the present invention.

### DETAILED DESCRIPTION

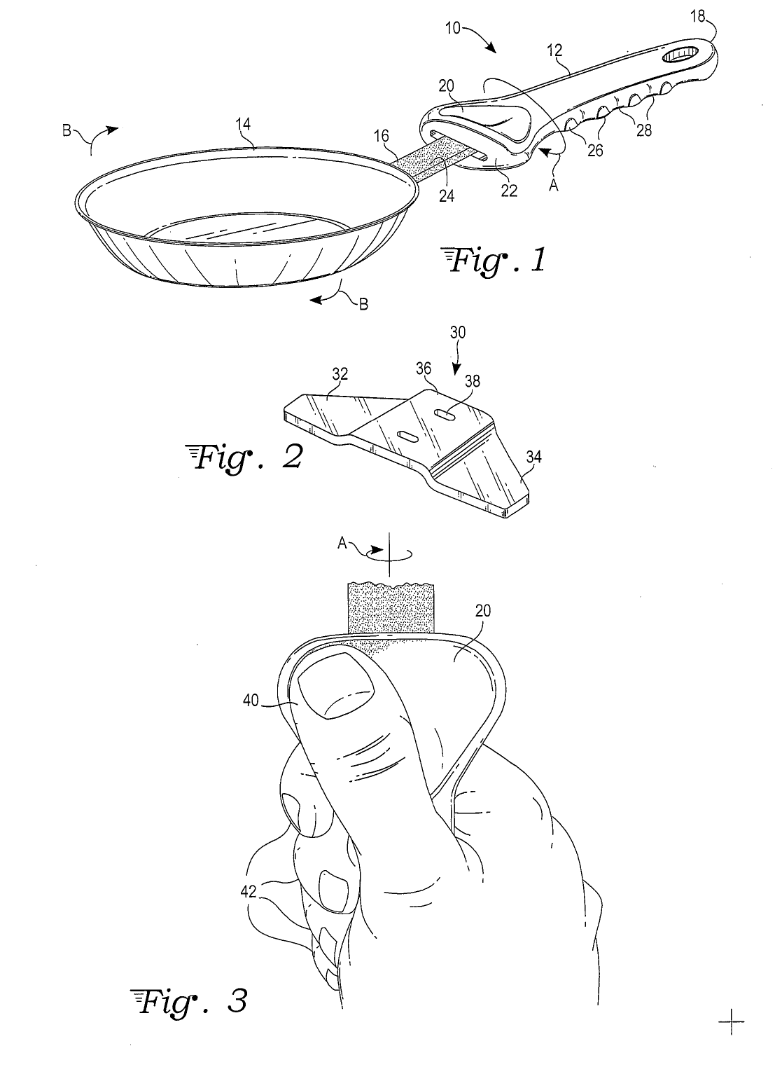

With reference to FIG. 1, an embodiment of a handle 10 in accord with the present invention is connected to a cooking implement 14. The handle comprises an axially elongate body 12 having an attachment end 16 adapted to receive an implement 14 and a free end 18 distal from the implement 14. The handle 10 includes a widened thumb rest 20. The thumb rest 20 may have a recessed pad surface.

In particular, the elongated body 12 is widened proximal to its attachment end 16 to define the thumb rest 20, which extends laterally outward from sides of the elongate body so as to provide leverage for axial rotation of the elongated body and turning of an implement connected thereto. In one handle construction, the elongate body may be in the form of a sleeve 22 having an axially elongate chamber in the body that is adapted to fit over a rigid shaft 24 extending from the implement 14. The sleeve may be either permanently fixed to the shaft or removable from shaft. It might comprise an injection molded polymer, e.g., composed of silicone rubber or a phenolic plastic. Any of a variety of polymer materials could be used. A set of ridges 26 define a corresponding set of finger depressions 28 between the ridges in the elongate handle body 12 at locations corresponding to a hand grip upon the handle.

FIG. 2 is perspective view of a metal cross-plate 30 that may be provided within the handle 10 of FIG. 1 to provide additional mechanical strength to the thumb rest 20. The metal cross-plate, when connected via screws in holes 38 in center portion 36, will extend laterally outward beyond the sides of the elongate body proximal to the attachment end 16. The metal cross-plate is constructed so as to provide mechanical strength to the thumb rest, e.g. via rigid metal wing portions 32 and 34.

In FIG. 3, the handle is seen being gripped by a hand with placement of a thumb 40 upon the widened thumb rest 20 and fingers 42 curled around the elongate body of the handle. For a handle with elongate body generally of from 3 to 4 cm width, the thumb rest is typically widened laterally outward to a width of from 6 to 8 cm, such that the outermost portions of the thumb rest 20 extend at least 1 cm beyond the remainder of both sides of the elongate body. This provides adequate leverage for rotating the implement about the axis of the handle as indicated by arrow A in FIG. 3 and arrow B in FIG. 1. The leverage increases rotational torque without over-stressing the forearm during pronation. This reduction in stress can be enhanced by using an elongate body that has a rounder cross-sectional shape, particularly on the bottom where the fingers curl.

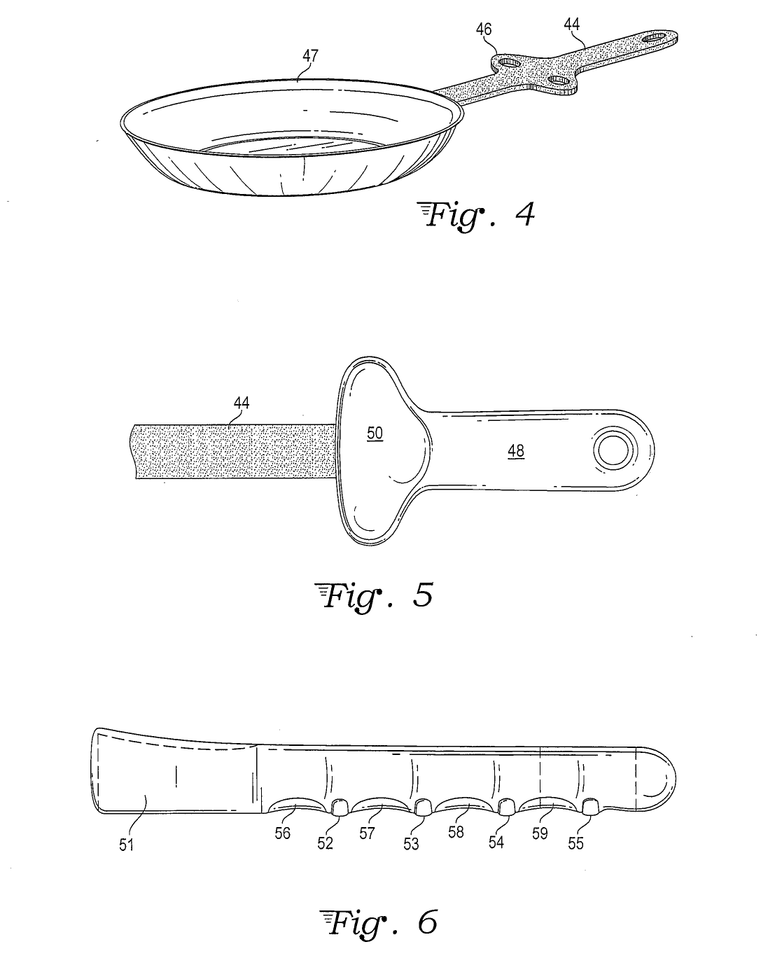

A handle connected to a cooking implement 47 is seen in FIG. 4 with its outer sleeve removed to reveal its underlying rigid shaft 44 with integral crossbar 46 at a location corresponding to the thumb rest. The rigid crossbar is integrated with shaft 44 proximal to its attachment end to implement 47. The crossbar 46 extends laterally outward from sides of the rigid shaft 44. Holes in the crossbar 46 may be provided to reduce weight. As seen in FIG. 5, an outer sleeve 48 fits over the shaft 44. In particular, the sleeve may be composed of an elastomer (such as silicone rubber) that is adapted stretch over the crossbar 46 so as to define the thumb rest 50. Alternatively, the elastomer may be injection molded directly onto the shaft and crossbar. Typical dimensions may be 28-32 mm width for the main part of the sleeve and 60-80 mm width for the widened thumb rest area, where the handle length is at least 100 mm and preferably 115 mm long from the free end to the beginning of the thumb rest, and an extra 25-40 mm length for the thumb rest itself, giving an typical length of 140 mm, and more generally 120-160 mm, for the entire handle. However, these typical dimensions can vary, depending on the particular implement to which the handle attaches.

As seen in FIG. 6, a handle 51 includes the presence of a set of circumferentially oriented ridges 52-55 successively spaced apart toward the free end of the handle 51. The ridges 52-55 define a corresponding set of finger depressions 56-59 between the ridges in the elongate handle body at locations corresponding to a hand grip upon the handle 51. The finger depressions 56-59 provide a sure grip upon the surface of the handle 51 without having to grip too tightly, thereby reducing stress on the forearm. A typical ridge-to-ridge distance is approximately 20 mm for best hand feel. The sleeve material for the handle body can be a solid elastomer, such as silicone, such that no internal support or handle shaft modifications are required.

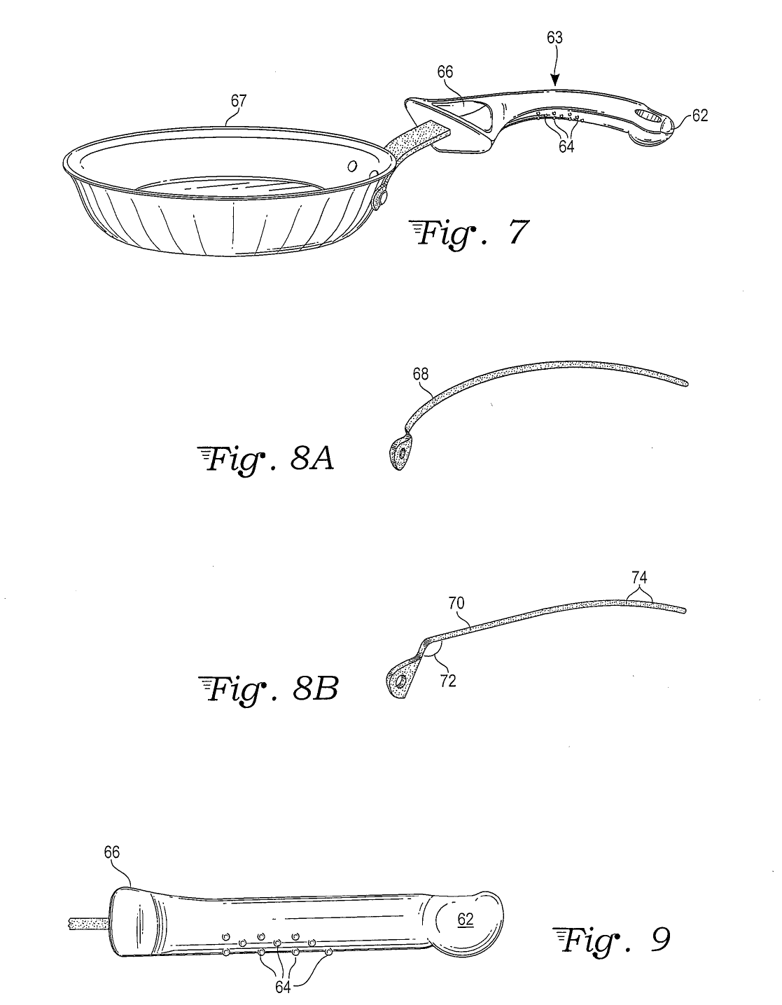

In FIG. 7 another embodiment of a handle 63 is connected to a cooking implement 67. As seen in FIGS. 8A and 8B, the handle shaft may have any amount of curvature that an ergonomic designer wishes to give it for ease of handling the implement. This may be specific to the size, shape and weight of the particular implement. In FIG. 8A the handle shaft 68 is curved over its entire length, while in FIG. 8B the handle shaft 70 is angled sharply upwards at an angle 72 at the connection to the implement but is otherwise only slightly curved near its free end 74 to increase user control of the handled implement. The sleeve material for the handle body may be an elastomeric material that will conform to the curvature of a curved shaft when installed. The close-up view in FIG. 9 shows a set of raised dimple texture features 64 that may be distributed over a portion of the handle surface on the free end side of the thumb rest 66, particularly in areas corresponding to locations of a palm and fingers of a hand grip upon the handle. A ball knob 62 may terminate the free end of the handle.

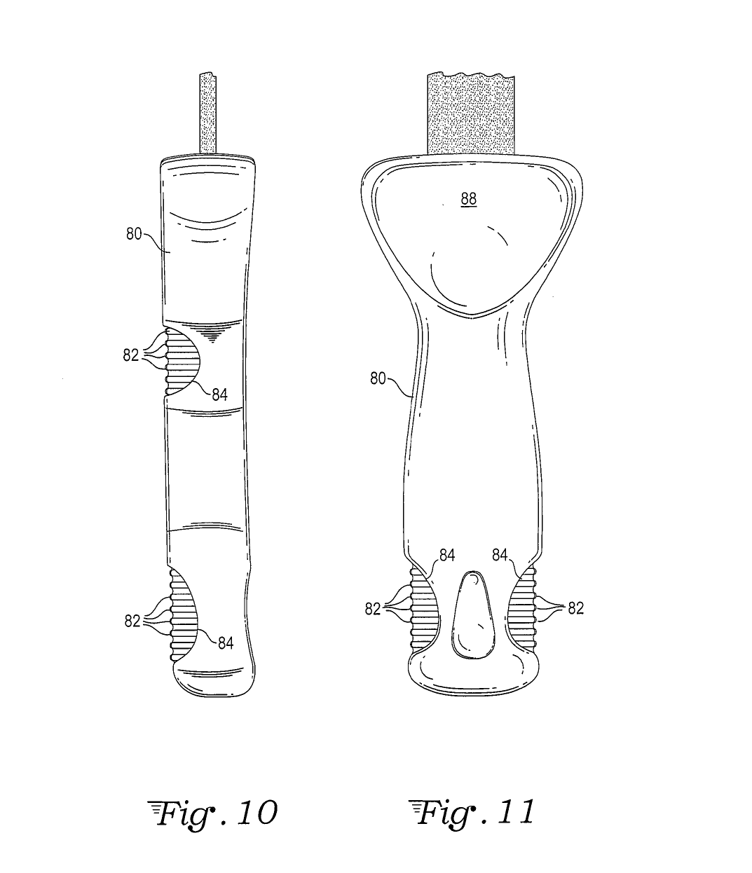

FIGS. 10 and 11 show yet another embodiment of a handle 80 with a thumb rest 88 in accord with the present invention, featuring sets of elastomer ridges or fins 82 that may define flexible finger depressions in the handle surface. The body of the handle is here shown having a pair of ridge areas at locations that correspond to normal placement of index and pinky fingers of a hand grip upon the elongate handle body 80. Each of the ridge areas may have multiple elastomer ridges or fins 82 extending outward from depressions 84 in the elongate body, but generally flush with the overall surface of the elongate body so as to be adapted to flexibly yield to finger pressure thereon.

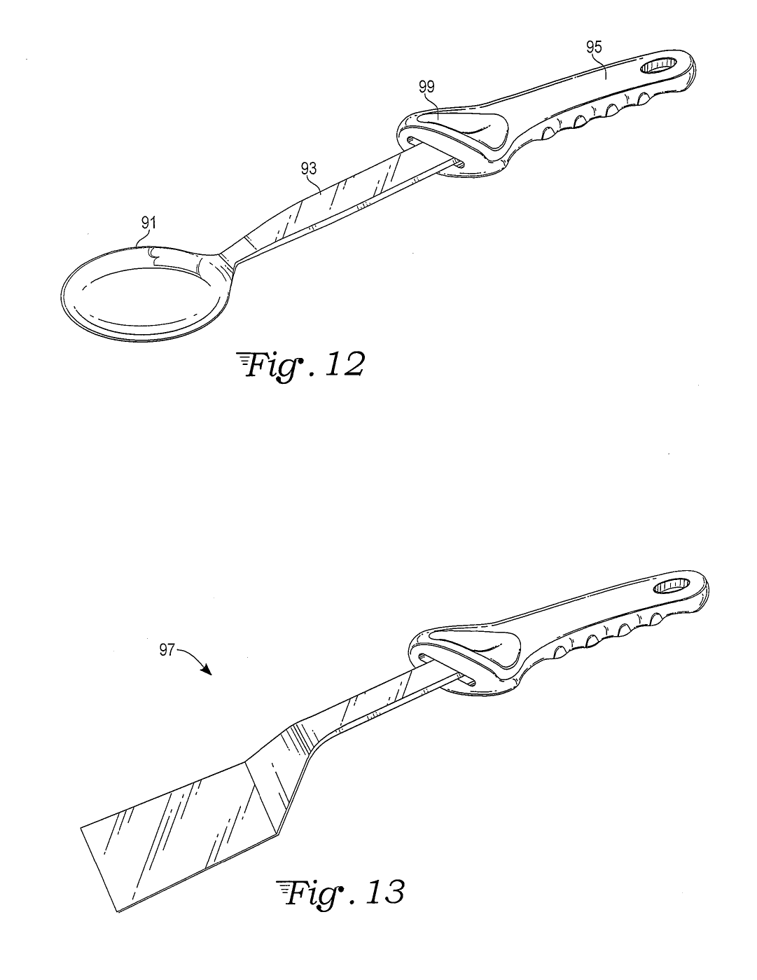

FIGS. 12 and 13 illustrate that the implement or tool from which the handle extends need not be a cooking pan, as seen for example in FIGS. 1, 4, and 7, but can be any of a wide variety of implements, both for cooking and other applications. Thus, in FIG. 12, the tool is a spoon or ladle 91 having a handle 93 with sleeve-type grip 95 like any of the previously described handles and grips. In FIG. 13, the tool is a spatula 97. The grip 95 is characterized by having a thumb rest 99 extending laterally outward from its sides so as to provide leverage for axial rotation of the handle 93 and its associated implement 91 (or 97). As in any of the preceding implements, the handle and its associated sleeve, or grip may be made with a variety of materials and constrictions.

1. A handle, comprising:
an axially elongate body having an attachment end adapted to receive an implement and a free end distal from the implement, the elongated body widened proximal to its attachment end to define a thumb rest extending laterally outward from sides of the elongate body so as to provide leverage for axial rotation of the elongated body and turning of an implement connected thereto.

2. The handle as in claim 1, wherein the elongate body is in the form of a sleeve having an axially elongate chamber in the body that is adapted to fit over a rigid shaft extending from the implement.

3. The handle as in claim 2, wherein the rigid shaft has a rigid crossbar integrated therein proximal to the attachment end, the crossbar extending laterally outward from sides of the rigid shaft, the sleeve composed of an elastomer adapted to fit over the crossbar.

4. The handle as in claim 1, wherein the thumb rest includes a metal cross-plate extending laterally outward beyond the sides of the elongate body proximal to the attachment end, the metal cross-plate constructed so as to provide mechanical strength to the thumb rest.

5. The handle as in claim 1, wherein a set of raised dimples are distributed over at least a portion of the elongate body on the free end side of the thumb rest.

6. The handle as in claim 1, wherein the elongate body has a set of circumferentially oriented ridges spaced apart successively toward the free end and defining a set of finger depressions between the ridges in the elongate body at locations corresponding to a hand grip upon the elongate body.

7. The handle as in claim 1, wherein the elongate body has a pair of separated ridge areas at locations corresponding to index and pinky fingers of a hand grip upon the elongate body, each of the ridge areas having multiple elastomer ridges or fins extending outward from depressions in the elongate body and generally flush with the overall surface of the elongate body so as to be adapted to flexibly yield to finger pressure thereon.

8. The handle as in claim 1, wherein the thumb rest has a recessed pad surface.

9. The handle as in claim 1, wherein the free end of the elongate body has knob.

10. The handle as in claim 1, wherein, for an elongate body generally of from 3 to 4 cm width, the thumb rest is widened laterally outward to a width of from 6 to 8 cm such that the outermost portions of the thumb rest extend at least 1 cm beyond the remainder of both sides of the elongate body.

11. A grip for a handle, comprising:
an axially elongate sleeve with an elongate chamber therein adapted to fit over a rigid handle shaft extending from an implement, the sleeve widened at one end to define a thumb rest extending laterally outward from sides of the sleeve, so that when the sleeve is fit over the handle shaft with the thumb rest proximal to the implement the thumb rest provides leverage for axial rotation of the handle shaft and turning of the implement connected thereto.

12. The grip as in claim 11, wherein the thumb rest includes a metal cross-plate within the elongate chamber that is attachable to the handle shaft proximal to the implement so as to extend laterally outward from sides of the handle shaft, the metal cross-plate constructed so as to provide mechanical strength to the thumb rest.

13. The grip as in claim 11, wherein the sleeve is composed of an elastomer and is adapted to fit over a rigid crossbar integrated with the handle shaft proximal to the implement such that the thumb rest defined by the widening of the sleeve is positioned over the crossbar.

14. The grip as in claim 11, wherein a set of raised dimples are distributed over at least a portion of the sleeve.

15. The grip as in claim 11, wherein the sleeve has a set of circumferentially oriented ridges spaced apart successively toward the end opposite from the thumb rest and defining a set of finger depressions between the ridges in the sleeve at locations corresponding to a hand grip upon the sleeve.

16. The grip as in claim 11, wherein the sleeve has a pair of separated ridge areas at locations corresponding to index and pinky fingers of a hand grip upon the sleeve, each of the ridge areas having multiple elastomer ridges or fins extending outward from depressions in a surface of the sleeve and generally flush with the overall surface of the sleeve so as to be adapted to flexibly yield to finger pressure thereon.

17. The grip as in claim 11, wherein the thumb rest has a recessed pad surface.

18. The grip as in claim 11, wherein the sleeve has a knob at an opposite end from the thumb rest.

19. The grip as in claim 11, wherein, for sleeve generally of from 3 to 4 cm width, the thumb rest is widened laterally outward to a width of from 6 to 8 cm such that the outermost portions of the thumb rest extend at least 1 cm beyond the remainder of both sides of the sleeve.
